(19) United States
(12) Patent Application Publication
(10) Pub. No.: US 2013/0335223 A1
(43) Pub. Date: Dec. 19, 2013

(54) ELECTRONICS THEFT DETERRENT SYSTEM

(71) Applicants: Douglas S. Brown, Charlotte, NC (US); John F. Kelley, Clarkesville, GA (US); Todd Seager, Orem, UT (US)

(72) Inventors: Douglas S. Brown, Charlotte, NC (US); John F. Kelley, Clarkesville, GA (US); Todd Seager, Orem, UT (US)

(73) Assignee: International Business Machines Corporation, Armonk, NY (US)

(21) Appl. No.: 13/525,543

(22) Filed: Jun. 18, 2012

(51) Int. Cl. G08B 13/14

(52) U.S. Cl. 340/568.1

(57) ABSTRACT

Embodiments of the present invention provide a method and system of deterring theft of an electronic device connected to an external source of charging power. In one aspect, responsive to a user request to arm the electronic device and the electronic device being connected to the source of charging power, the electronic device arming the electronic device. In another aspect, while the electronic device is armed, the electronic device detecting loss of the connection to the source of charging power, and in response, the electronic device activating an alarm or notifying another computing device that the connection of the electronic device has been disconnected from the source of charging power.

The present invention relates generally to a theft deterrent system for an electronic device such as a laptop computer.

### BACKGROUND

The small size and portability of laptop computers makes them prone to theft when unattended. Many styles of security devices have been developed to address the theft of electronic devices. For example, U.S. Pat. No. 7,218,221 describes a theft deterrent system in which a portable device wirelessly communicates with a computer at a set interval or scan rate from a remote location to monitor theft of the portable device. The computer includes a receiver that confirms communication between the computer and the portable device. The computer also includes a controller that automatically adjusts a scan rate of the receiver. For example, when the portable device is remote from the computer, the controller may increase the scan rate. Similarly, when the portable device is in close proximity to the computer, the controller may decrease the scan rate. U.S. Pat. Pub. No. US 2011/0076986 A1 describes theft deterrent techniques for mobile devices in which a mobile device communicates with a server to obtain a security status for the mobile device. The mobile device transmits a user entered authentication code to the server, and if the authentication code cannot be verified, the server disables functionality of the mobile device.

### SUMMARY

In one embodiment of the present invention, a method is provided of deterring theft of an electronic device connected to an external source of charging power, comprising, responsive to a user request to arm the electronic device and the electronic device being connected to the source of charging power, the electronic device arming the electronic device, and while the electronic device is armed, the electronic device detecting loss of the connection to the source of charging power, and in response, the electronic device activating an alarm or notifying another computing device that the electronic device has been disconnected from the source of charging power.

### BRIEF DESCRIPTION OF THE SEVERAL VIEWS OF THE DRAWINGS

Novel characteristics of the invention are set forth in the appended claims. The invention itself, however, as well as preferred mode of use, further objectives, and advantages thereof, will be best understood by reference to the following detailed description of the invention when read in conjunction with the accompanying figures, wherein like reference numerals indicate like components, and:

FIG. 1 is a functional block diagram of electronics theft deterrent system 100, according to an embodiment of the present invention.

FIG. 2A is a flowchart depicting the steps performed by theft deterrent program 120 of electronic device 110 of FIG. 1, according to an embodiment of the present invention.

FIG. 2B is a flowchart depicting the steps performed by mobile theft deterrent program 190 of mobile device 115 of FIG. 1, according to an embodiment of the present invention.

FIG. 3 illustrates an AC-DC conversion circuit 300 that activates an alarm on electronic device 110 and mobile device 115 of FIG. 1, according to an embodiment of the present invention.

FIG. 4 illustrates a block diagram of the components of a computer, such as electronic device 110 and mobile device 115 of FIG. 1, according to an embodiment of the present invention.

### DETAILED DESCRIPTION

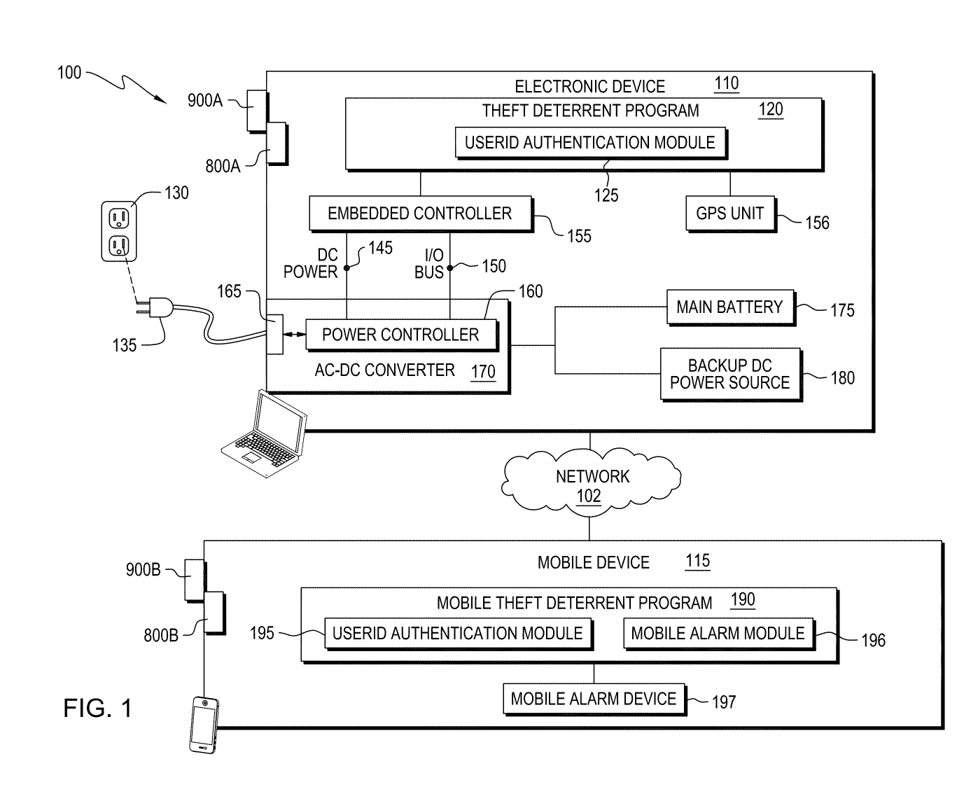

The present invention will now be described in detail with reference to the figures. FIG. 1 illustrates electronics theft deterrent system 100, according to an embodiment of the present invention. Electronics theft deterrent system 100 includes electronic device 110 and mobile device 115, interconnected over network 102. The owner of electronic device 110 typically owns mobile device 115 as well. As explained in more detail below, the owner interconnects electronic device 110 to AC power via an AC-DC converter 170, and “arms” electronic device 110 by commands to software within electronic device 110 (prior to leaving the electronic device in a public area) to report to the mobile device 115 via network 102 when the DC charging current to the electronic device 110 ceases. The DC charging current will cease if the AC-DC converter 170 is disconnected from the electronic device 110 or disconnected from the AC power such as by a thief. Exchange of communication between electronic device 110 and mobile device 115 can be performed using text messages or other types of signals transmitted over network 102.

Electronic device 110 can be, for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple, Inc., in the United States, other countries, or both), respectively. Electronic device 110 includes theft deterrent program 120, embedded controller 155, power controller 160, main battery 175, and backup power DC source 180.

Mobile device 115 can be, for example, a handheld device or smart phone, a personal digital assistant (PDA), an enhanced digital watch, a tablet computer, a notebook, a laptop computer, a thin client, or some other portable computing device capable of receiving wireless signals. Mobile device 115 may be wirelessly connected to network 102 by Wi-Fi or cellular technology. Mobile device 115 may include Bluetooth technology for short range wireless communications. Mobile device 115 may further include mobile theft deterrent program 190 and mobile alarm device 197.

Electronic device 110 and mobile device 115, each maintain respective internal components 800A and 800B and respective external components 900A and 900B. In general, electronic device 110 and mobile device 115 can be any programmable computing device as described in further detail below.

Network 102 can include one or more networks of any kind that can provide communication links between various devices and computers connected together within electronics theft deterrent system 100. Network 102 can also include connections, such as wired communication links, wireless communication links, or fiber optic cables. Network 102 can be implemented as a number of different types of networks, such as for example, an intranet, a local area network (LAN), or a wide area network (WAN).

AC-DC converter 170 comprises known technology which converts AC “wall” current to DC current for DC components of electronic device 110. AC-DC converter 170 receives AC power at connector 165 from electrical outlet 130 through plug 135 and the associated power cord. AC-DC converter 170 delivers the converted DC power to a main battery 175 and a smaller nonremovable backup DC power source 180 such as a small battery or a backup DC power source 180. Backup DC power source 180 has sufficient capacity to power the electronic device 110 for a few seconds, enough time to send a theft alert message to the mobile device 115. Backup DC power source 180 can be standard capacitors existing in a standard laptop computer, which perform the standard role of stabilizing the DC voltage during normal operation. Power controller 160 selectively delivers DC power from the output of the AC-DC converter 170 or the main battery 175 to the electronic components of electronic device 110 during normal operation. Backup DC power source 180 temporarily supplies DC power to electronic device 110 when the AC power cable is disconnected and the main battery 175 is removed from the electronic device 110, for example, by a thief attempting to silence an audible alarm from electronic device 110.

DC power 145 supplies power to embedded controller 155 and the other electronic components in electronic device 110. As explained in more detail below, power controller 160 also determines whether AC-DC converter 170 is currently generating DC power from the AC input (indicating that the electronic device 110 is currently plugged in to the wall outlet where the owner left it and is not being stolen). AC/DC converter 170 communicates the state of the DC power generation to embedded controller 155 via I/O bus 150. For example, if AC-DC converter 170 currently outputs DC power, power controller 160 sends a “1” or “high” signal to embedded controller 155. Otherwise, power controller 160 sends a “0” or “low” signal to embedded controller 155. Thus, a “low” signal indicates that AC power is not currently being supplied to connector 165 from electrical outlet 130, i.e., electric device 110 is no longer connected to electrical outlet 130.

Embedded controller 155 comprises a general purpose processor or an application specific processor that notifies theft deterrent program 120 whether the electronic device 110 is currently connected to the electrical outlet 130, based on the information obtained from the power controller 160. Theft deterrent program 120 includes userID authentication module 125. Mobile theft deterrent program 190 includes userID authentication module 195 and mobile alarm module 196 to receive theft alerts from the electronic device 110 and notify the owner.

UserID authentication modules 125, 195 operate in a traditional manner to validate userIDs and passwords that are entered to permit access to theft deterrent program 120 and mobile theft deterrent program 190, respectively.

The userID authentication module 125 displays an authentication screen and receives a userID and password from the owner of the electronic device 110. If the userID and password are valid, theft deterrent program 120 determines if the electronic device 110 is currently connected to electrical outlet 130 (based on information provided by embedded controller 155 as described above). If so, theft deterrent program 120 displays a user interface screen with an icon that the user can select to arm the theft deterrent program 120. Once armed, electronic device 110 displays a warning (such as a periodically flashing of a portion of the display screen on electronic device 110), respectively. Alternatively, electronic device 110 can include a separate LED which flashes to indicate the alarm condition. Optionally, theft deterrent program 120 can initiate a text message from electronic device 110 to mobile device 115 to indicate that the electronic device 110 is currently armed, but not triggered.

If and when AC power is disconnected from or discontinued to connector 165, power controller 160 interrupts embedded controller 155 via I/O bus 150, and in response, embedded controller 155 notifies theft deterrent program 120. In response, theft deterrent program 120 determines if it is still “armed”. If so, theft deterrent program 120 initiates a text message to mobile alarm device 197 of mobile device 115 indicating that AC power has been disconnected from the electronic device 110 or possible theft of the electronic device 110. If the main battery 175 has been removed there will still be sufficient power in the backup DC power source 180 to send the text message. After sending the text message, the theft deterrent program 120 activates an audible alarm via internal speakers of the electronic device 110.

Once activated, the audible alarm of electronic device 110 continues until disarmed via user access to the theft deterrent program 120 or by a user-initiated text message from the mobile device 115 to the electronic device 110 which is forwarded to the theft deterrent program 120. Further, after the alarm is activated, the theft deterrent program 120 periodically sends follow-up text messages to the mobile device 115 which state the current GPS location of the electronic device 110 (in those embodiments where the electronic device 110 is equipped with a GPS unit 156), and the theft deterrent program 120 cannot be uninstalled without a valid password.

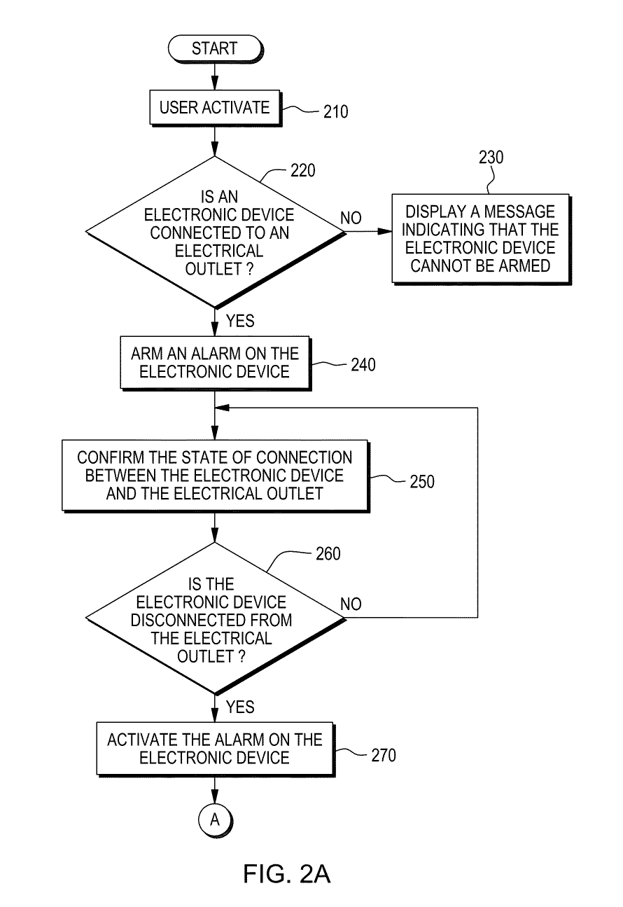

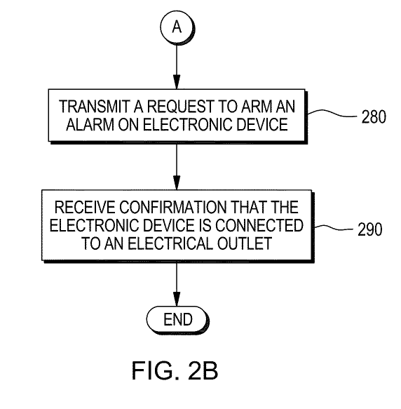

FIG. 2A is a flowchart depicting the steps performed by theft deterrent program 120 of electronic device 110 of FIG. 1, according to an embodiment of the present invention.

At step 210, a user activates theft deterrent program 120 to arm the theft deterrent system. Theft deterrent program 120 determines if the electronic device 110 is currently connected to AC power and if so, (Decision 220) theft deterrent program 120 arms electronic device 110 (Step 240). To “arm” the electronic device 110, theft deterrent program 120 makes a record to respond to a signal from the embedded controller 155 that the AC power connection has been lost and the resultant charging current has ceased, as follows. If the electronic device 110 is not currently connected to the electrical outlet 130 (Decision 220), the theft deterrent program 120 will display a message that theft deterrent mode cannot be armed unless the electronic device 110 is connected to AC power (Step 230). Next, the theft deterrent program 120 begins the theft detection mode. At step 250, theft deterrent program 120 checks the state of DC power supplied to embedded controller 155 or waits for an interrupt or message from the embedded controller 155 indicating loss of AC power/resultant charging current. At decision 260, if theft deterrent program 120 detects that the AC power has been disconnected, even momentarily, at step 270, theft deterrent program 120 activates the alarm mode (to send the text message to the mobile device 115 and activate the audible alarm. If the owner is in the vicinity of the electronic device 110, the owner can hurry back to the room where the owner left the electronic device 110 and possibly stop the theft, or if the thief has fled, take possession of the electronic device 110 and silence the audible alarm). However, if the theft deterrent program 120 does not detect the loss of AC power, theft deterrent program 120 does not enter the alarm mode. Theft deterrent program 120 repeatedly checks the connection to AC power, either by requesting this information or monitoring for alerts sent by the embedded controller indicating loss of AC power (Step 250).

FIG. 2B is a flowchart depicting the steps performed by mobile theft deterrent program 190 of mobile device 115 of FIG. 1, according to an embodiment of the present invention where the user arms the theft deterrent system 120 via the mobile device 115.

A user accesses mobile theft deterrent program 190 which provides a remote user interface for theft deterrent program 120. Next, the user enters a valid password and userID via the user interface of the mobile device 115. At step 280, responsive to a user request to arm the theft deterrent program 120 for electronic device 110 via the remote user interface, mobile theft deterrent program 190 conveys this request to theft deterrent program 120. In response, theft deterrent program 120 determines whether the electronic device 110 is currently receiving AC power (Step 290), and if so, arms the theft deterrent program 120 as described above, and notifies the mobile theft deterrent program 190 that the theft deterrent program 120 is currently armed. In response, mobile device 115 displays a message in the user interface that the theft deterrent program 120 is currently armed.

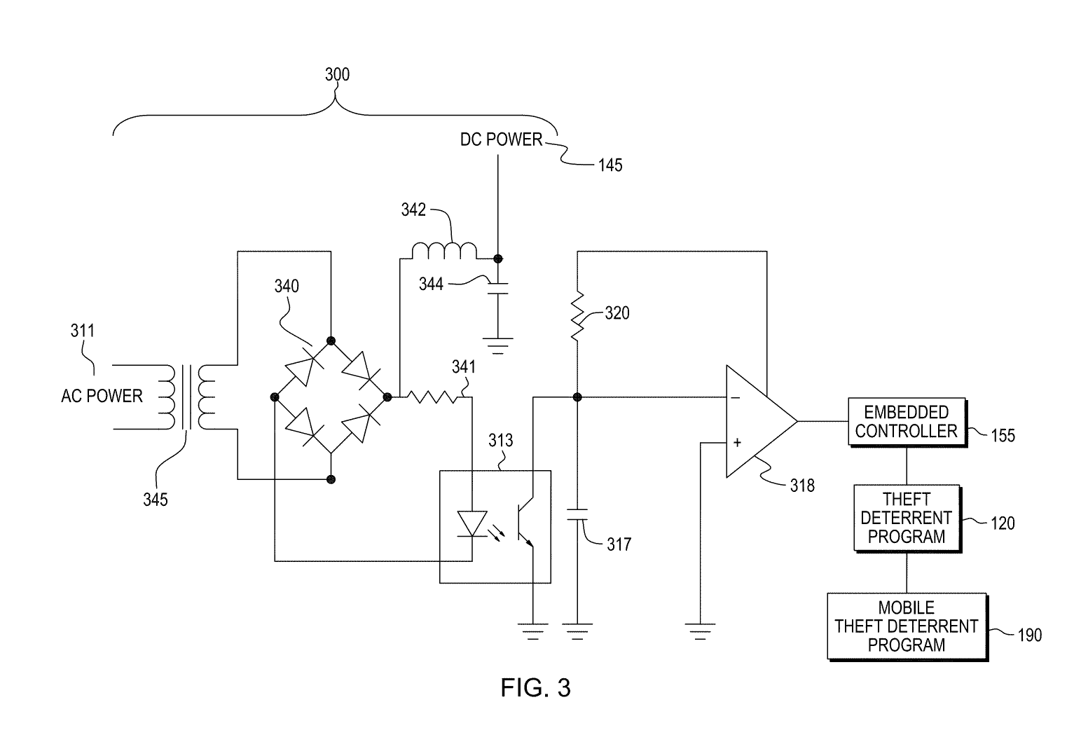

FIG. 3 illustrates an AC-DC conversion circuit 300 that activates electronic device 110 and mobile device 115 shown in FIG. 1, according to an embodiment of the present invention.

AC-DC conversion circuit 300 receives AC power 311 from electrical outlet 130 of FIG. 1. Transformer 345 steps down AC power 311 to approximately ten (10) volts root mean squared (RMS), and a full wave rectification bridge 340 generates a corresponding full wave rectified DC power 341. A low pass filter comprising a series inductor 342 and a parallel capacitor 344 filter much of the AC power 311 that passes through the rectification bridge 340, and supplies DC power 145 to power the electronic device 110. (The actual level of requisite DC power 341 depends on the technology used in electronic device 110. Various electronic devices may require a DC voltage in the range of 5-15 Volts.)

An output from AC-DC conversion circuit 300 is also used to indicate the presence or absence of a connection to AC power 311, as follows. DC power 341 triggers opto-coupler 313 which drives inverting amplifier 318. While AC power 311 is applied to electronic device 110, the input to inverting amplifier 318 is low because opto-coupler 313 conducts and capacitor 317 is discharged through the transistor/collector output of opto-coupler 313, thus the output of inverting amplifier 318 is high. Conversely, when AC power 311 is not applied to plug 135, opto-coupler 313 is not triggered, thus capacitor 317 is charged through resistor 320, the input to inverting amplifier 318 is high and the output of inverting amplifier 318 is low.

Embedded controller 155 is interposed between the output of inverting amplifier 318 and the input of theft deterrent program 120. Therefore, if AC power 311 is applied to electronic device 110, and thus DC power 341 is generated, the output of inverting amplifier 318 is high. Thus, a high signal is transmitted to embedded controller 155 which notifies theft deterrent program 120 that electronic device 110 is currently plugged into the same AC power outlet. Therefore, this signifies that the electronic device 110 has not been stolen.

However, if plug 135 is removed from electronic device 110, and thus AC power 311 is not supplied to electronic device 110, the output of inverting amplifier 318 is low. Therefore, the low signal is transmitted to embedded controller 155 which notifies theft deterrent program 120 that the electronic device 110 is no longer connected to the AC power 311. In response, theft deterrent program 120 activates the alarm as described above, if the theft deterrent program 120 is armed. Theft deterrent program 120 also initiates a text message to mobile device 115 to alert the owner that the alarm has been activated because the electronic device 110 has been disconnected from AC power 311. The text message also notifies mobile theft deterrent program 190 to activate an mobile alarm device 197.

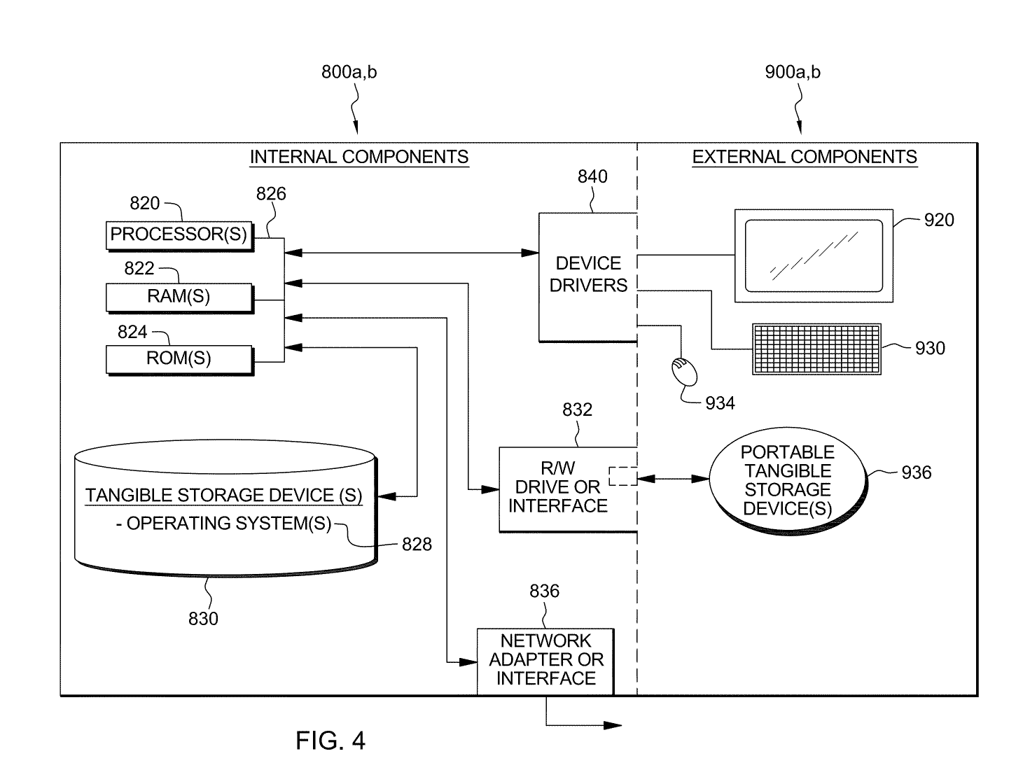

FIG. 4 illustrates a block diagram of the components of a computer, such as electronic device 110 and mobile device 115 of FIG. 1, according to an embodiment of the present invention is depicted.

Electronic device 110 include respective set of internal components 800a and external components 900a, and mobile device 110 include set of internal components 800b and a set of external components 900b, illustrated in FIG. 1. Each of the sets of internal components 800a,b includes one or more processors 820, one or more computer-readable RAMs 822 and one or more computer-readable ROMs 824 on one or more buses 826, one or more operating systems 828 and one or more computer-readable tangible storage devices 830. The one or more operating systems 828 and theft deterrent program 120 (for electronic device 110) and mobile theft deterrent program 190 (for mobile device 115) are stored on one or more of the respective computer-readable tangible storage devices 830 for execution by one or more of the respective processors 820 via one or more of the respective RAMs 822 (which typically include cache memory). In the illustrated embodiment, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a RAW drive or interface 832 to read from and write to one or more portable computer-readable tangible storage devices 936 such as a CD-ROM, DVD, memory stick, magnetic tape, magnetic disk, optical disk or semiconductor storage device. The theft deterrent program 120 (for electronic device 110) and mobile theft deterrent program 190 (for mobile device 115) can be stored on one or more of the respective portable computer-readable tangible storage devices 936, read via the respective RAW drive or interface 832 and loaded into the respective hard drive or semiconductor storage device 830.

Each set of internal components 800a,b also includes a network adapter or interface 836 such as a TCP/IP adapter card or wireless communication adapter (such as a 4G wireless communication adapter using OFDMA technology). The theft deterrent program 120 (for electronic device 110) and mobile theft deterrent program 190 (for mobile device 115) can be downloaded to the respective computing/processing devices from an external computer or external storage device via a network (for example, the Internet, a local area network or other, wide area network or wireless network) and network adapter or interface 836. From the network adapter or interface 836, the programs are loaded into the respective hard drive or semiconductor storage device 830. The network may comprise copper wires, optical fibers, wireless transmission, routers, firewalls, switches, gateway computers and/or edge servers.

Each of the sets of external components 900a,b includes a display screen 920, a keyboard or keypad 930, and a computer mouse or touchpad 934. Each of the sets of internal components 800a,b also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in storage device 830 and/or ROM 824).

The programs can be written in various programming languages (such as Java, C+) including low-level, high-level, object-oriented or non object-oriented languages. Alternatively, the functions of the programs can be implemented in whole or in part by computer circuits and other hardware (not shown).

Based on the foregoing a method and system of deterring theft of an electronic device connected to a source of charging power has been disclosed. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. Therefore, the present invention has been disclosed by way of example and not limitation.

What is claimed is:

1. A method of deterring theft of an electronic device connected to an external source of charging power, the method comprising the steps of:
responsive to a user request to arm the electronic device and the electronic device being connected to the source of charging power, the electronic device arming the electronic device; and
while the electronic device is armed, the electronic device detecting loss of the connection to the source of charging power, and in response, the electronic device activating an alarm or notifying another computing device that the electronic device has been disconnected from the source of charging power.

2. The method of claim 1, wherein the external source of charging power is AC, and the step of the electronic device detecting loss of the connection to the source of charging power, comprises the step of monitoring an output of an AC-DC converter within the electronic device to detect loss of DC voltage.

3. The method of claim 1, wherein the electronic device notifies the other computing device that the electronic device has been disconnected from the source of charging power by sending a text message to the other computing device.

4. The method of claim 3, wherein the other computing device responds to the text message by sounding an audible alarm from the other computing device.

5. The method of claim 1, wherein the electronic device comprises an AC power to DC power converter whose output indicates whether the electronic device is currently plugged into the source of charging power.

6. The method of claim 1, wherein the electronic device includes (a) a main battery to provide power for the step of activating an alarm or notifying another computing device that the electronic device has been disconnected from the source of charging power, and (b) sufficient internal capacitance connected to a DC power plane within the electronic device, to perform the step of notifying another computing device that the electronic device has been disconnected from the source of charging power, upon removal of the main battery.

7. The method of claim 1, wherein the electronic device is a laptop computer.

8. A computer system for deterring theft of an electronic device connected to an external source of charging power, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to arm an alarm in the electronic device responsive to a user request to arm the alarm and the electronic device being connected to the source of charging power; and
program instructions to receive notification of loss of the connection to the source of charging power while the electronic device is armed, and in response, activate an alarm.

9. The computer system of claim 8, further comprising:
program instructions, stored on at least one of the one or more storage devices for execution by at least one of the one more processors via at least one of the one or more memories, the program instructions comprising:
program instructions to monitor an output of an AC-DC converter within the electronic device to detect loss of DC voltage.

10. The computer system of claim 8, wherein the program instructions to arm an alarm in the electronic device responsive to a user request to arm the alarm and the electronic device being connected to the source of charging power, comprises program instructions to indicate whether the electronic device is currently plugged into the source of charging power.

11. The computer system of claim 8, wherein the electronic device includes (a) a main battery to provide power to the electronic device, and (b) sufficient internal capacitance connected to a DC power plane within the electronic device, to power the electronic device, upon removal of the main battery.

12. The computer system of claim 8, wherein the electronic device is a laptop computer.

13. A computer system for deterring theft of an electronic device connected to an external source of charging power, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to arm an alarm in the electronic device responsive to a user request to arm the alarm and the electronic device being connected to the source of charging power;
program instructions to receive notification of loss of the connection to the source of charging power while the electronic device is armed, and in response, activate an alarm; and
program instructions to notify another computing device that the electronic device has been disconnected from the source of charging power.

14. The computer system of claim 13, wherein the program instructions to notify another computing device that the electronic device has been disconnected from the source of charging power, comprises program instructions to send a text message to the other computing device.

15. The computer system of claim 14, wherein the other computing device comprises program instructions to respond to the text message by sounding an audible alarm.

16. The computer system of claim 13, wherein the electronic device includes (a) a main battery to provide power to the electronic device, and (b) sufficient internal capacitance connected to a DC power plane within the electronic device, to notify the other computing device that the electronic device has been disconnected from the source of charging power, upon removal of the main battery.
